(19) United States
(12) Patent Application Publication
(10) Pub. No.: US 2018/0086603 A1
(43) Pub. Date: Mar. 29, 2018

(54) ELEVATOR CAR

(71) Applicant: Otis Elevator Company, Farmington, CT (US)

(72) Inventors: Juan Jose Fernandez, Madrid (ES); Cristina Hernandez-Martin, Madrid (ES)

(21) Appl. No.: 15/712,412

(22) Filed: Sep. 22, 2017

(30) Foreign Application Priority Data
Sep. 23, 2016 (EP) 16190397.6

(51) Int. Cl. B66B 11/02

(52) U.S. Cl. CPC B66B 11/0226; B66B 5/0087; B66B 11/0233

(57) ABSTRACT

An elevator car comprises a ceiling and two bars extending parallel to and spaced apart from each other along the ceiling, wherein each of the bars comprises a first opening and a second opening. The elevator car further comprises a ceiling panel with two protrusions extending from opposite sides of the ceiling panel and configured such as to be received within the first openings, thereby allowing for a pivoting motion of the ceiling panel around an axis extending between the two protrusions; and at least one locking mechanism, which is switchable between a locked state and an unlocked state. In its locked state, the at least one locking mechanism engages with one of the second openings for locking the ceiling panel to at least one of the bars when the ceiling panel is pivoted into an operating position.

The invention relates to an elevator car, in particular an elevator car comprising a removable inner ceiling panel.

Elevator cars are usually equipped with lighting elements which are configured for illuminating the interior of the elevator car. Installation of and access to the lighting elements, e.g. for replacement and maintenance, may be difficult.

It therefore would be beneficial to provide an elevator car which allows for an easy access to lighting elements provided for illuminating the interior of the elevator car, in particular to lighting elements which are arranged at the ceiling of the elevator car.

According to an exemplary embodiment of the invention, an elevator car comprises a ceiling defining a top end of the interior space of the elevator car and two bars, a first bar and a second bar, extending parallel to and spaced apart from each other along the ceiling. Each of the bars comprises at least one first opening and at least one second opening. The elevator car further comprises a ceiling panel with two protrusions, a first protrusion and a second protrusion, extending from opposite sides of the panel. Each protrusion is configured such as to be received within a first opening of one of the bars and for allowing for a pivoting motion of the ceiling panel around an axis extending between the two protrusions. The ceiling panel is also equipped with at least one locking mechanism, which is switchable between a locked state and an unlocked state. In its locked state, the at least one locking mechanism engages with one of the second openings for locking the ceiling panel to at least one of the bars when the ceiling panel is pivoted into an operating position in which the ceiling panel extends parallel to the bars. In its unlocked state, the least one locking mechanism allows the ceiling panel to pivot from the operating position to a maintenance position in which the ceiling panel is inclined at an angle of more than 0° with respect to the bars.

Exemplary embodiments of the invention further include an elevator system comprising at least one elevator car according to an exemplary embodiment of the invention.

Exemplary embodiments of the invention also include a method of mounting a ceiling panel in an elevator car, wherein the method comprises the steps of: introducing the first protrusion into a first opening of the first bar, introducing the second protrusion into a first opening of the second bar, pivoting the ceiling panel upwards around the axis extending between the protrusions, and locking the ceiling panel to at least one of the bars by means of the at least one locking mechanism when the ceiling panel is oriented parallel to the bars.

Exemplary embodiments of the invention further include a method of removing a ceiling panel from an elevator car, wherein the method comprises the steps of: unlocking the at least one locking mechanism, pivoting the ceiling panel downwards around the axis extending between the protrusions, and extracting the protrusions from the respective first openings.

Exemplary embodiments of the invention allow for an easy installation and removal of a ceiling panel of an elevator car.

The ceiling panel in particular may comprise and/or support lighting elements, which are configured for lighting the interior space of the elevator car. Such a ceiling panel allows for an easy installation and maintenance of lighting elements in an elevator car.

Exemplary embodiments of the invention will be described in more detail with respect to the enclosed figures:

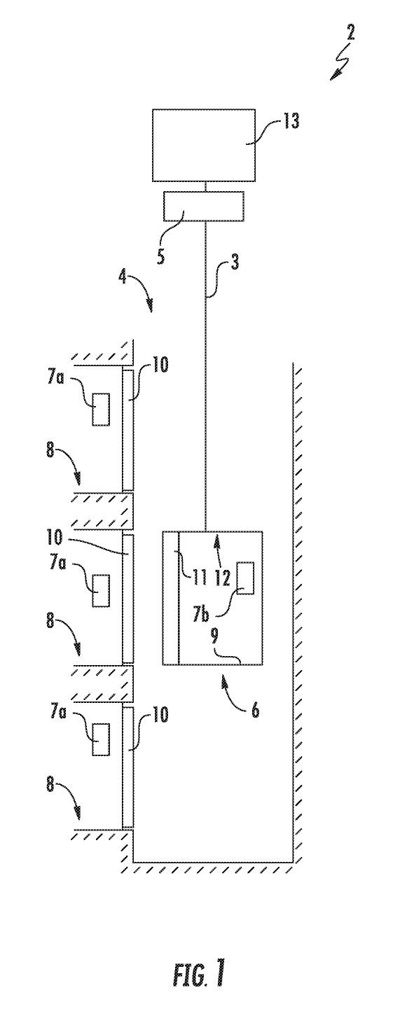

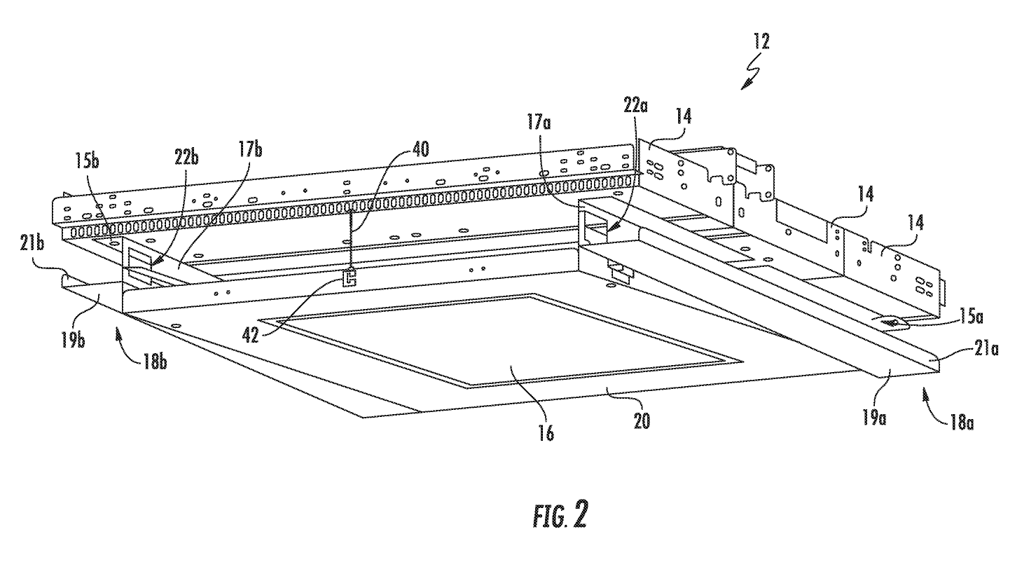

FIG. 1 schematically depicts an elevator system according to an exemplary embodiment of the invention.

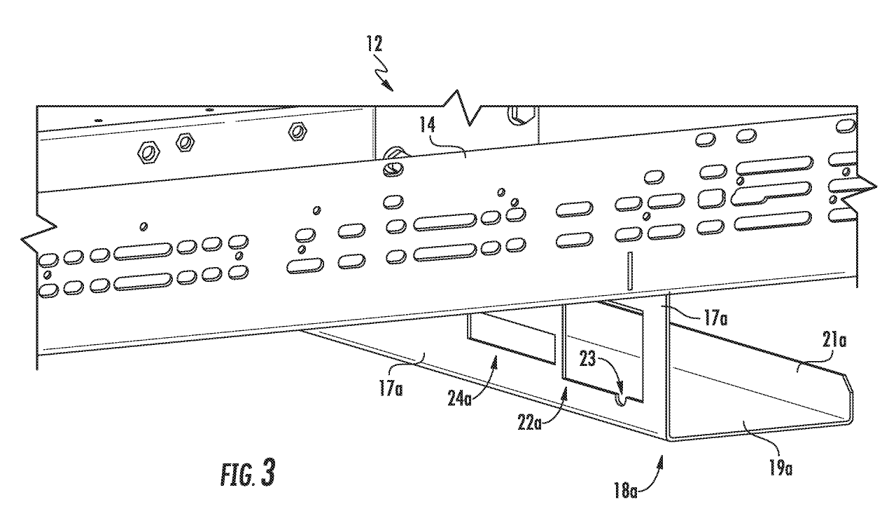

FIG. 2 depicts an enlarged perspective view of a portion of a ceiling of an elevator car according to an exemplary embodiment of the invention.

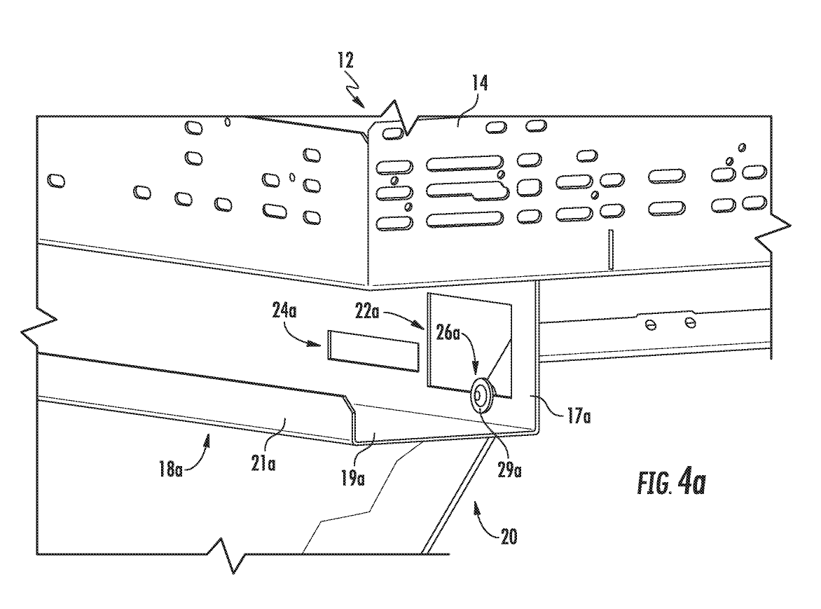

FIG. 3 depicts an enlarged partial view of a front area of a first bar attached to the ceiling of the elevator car.

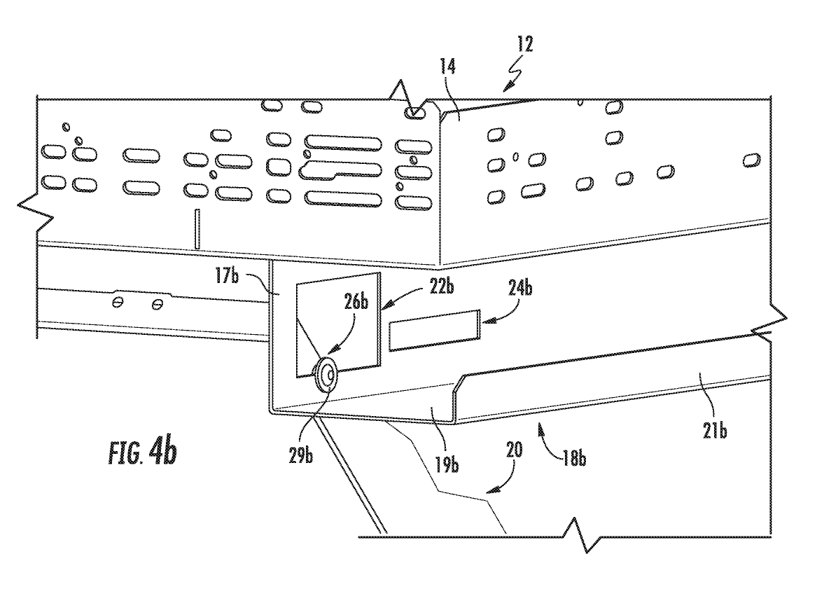

FIG. 4a depicts the first bar shown in FIG. 3 from an opposite viewing direction in combination with a ceiling panel.

FIG. 4b depicts a second bar attached to the ceiling of the elevator car for supporting the ceiling panel.

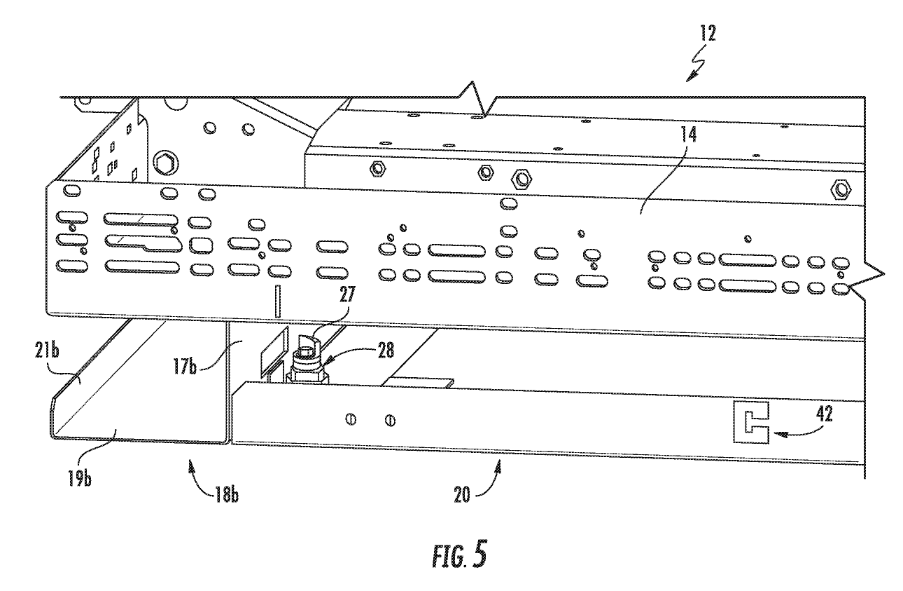

FIG. 5 depicts an enlarged partial view of the left portion shown in FIG. 2 with a locking mechanism, which is positioned in an unlocked position.

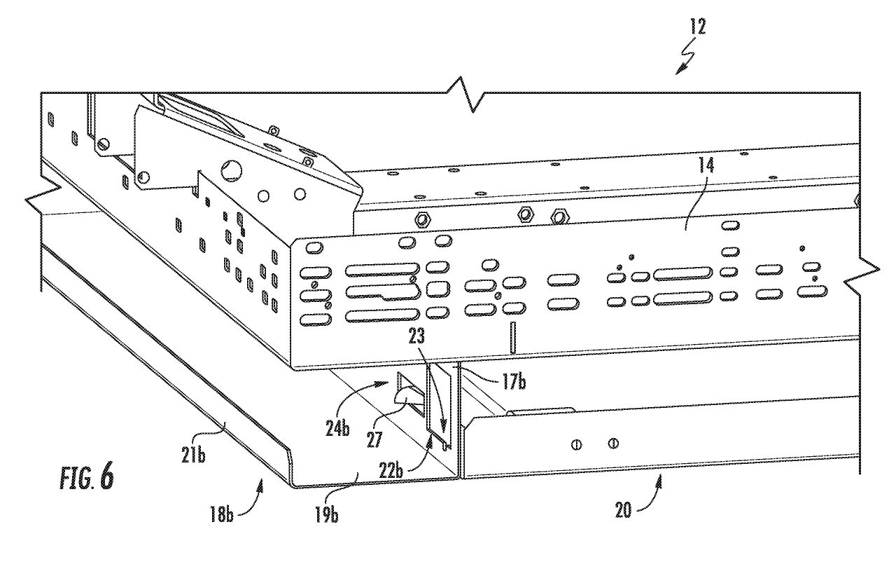

FIG. 6 depicts an enlarged partial view of the left portion shown in FIG. 2 with the locking mechanism, which is positioned in a locked position.

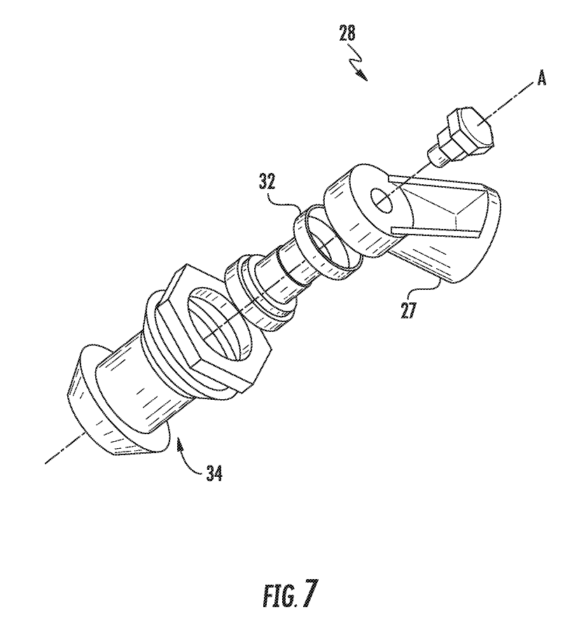

FIG. 7 depicts an explosive view of the locking mechanism shown in FIGS. 5 and 6.

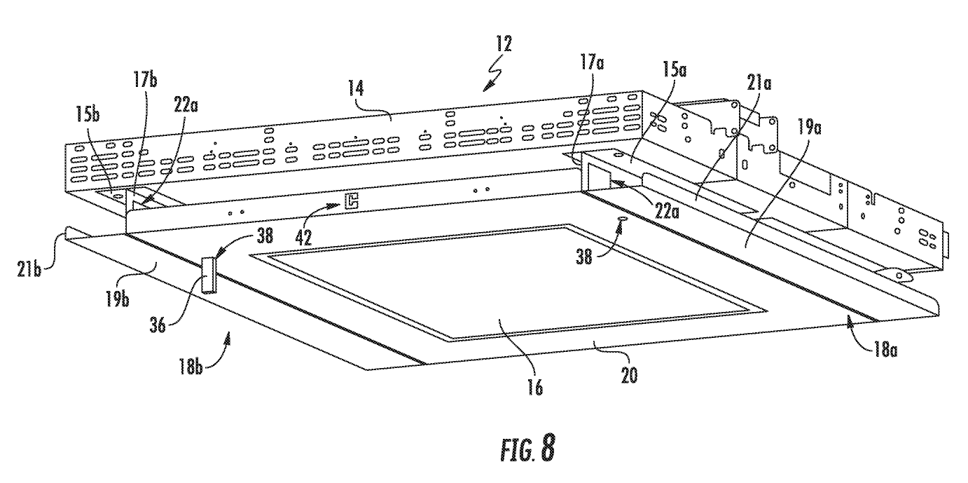

FIG. 8 depicts a configuration similar to FIG. 2, in which the ceiling panel is locked in an operating position extending parallel to the ceiling.

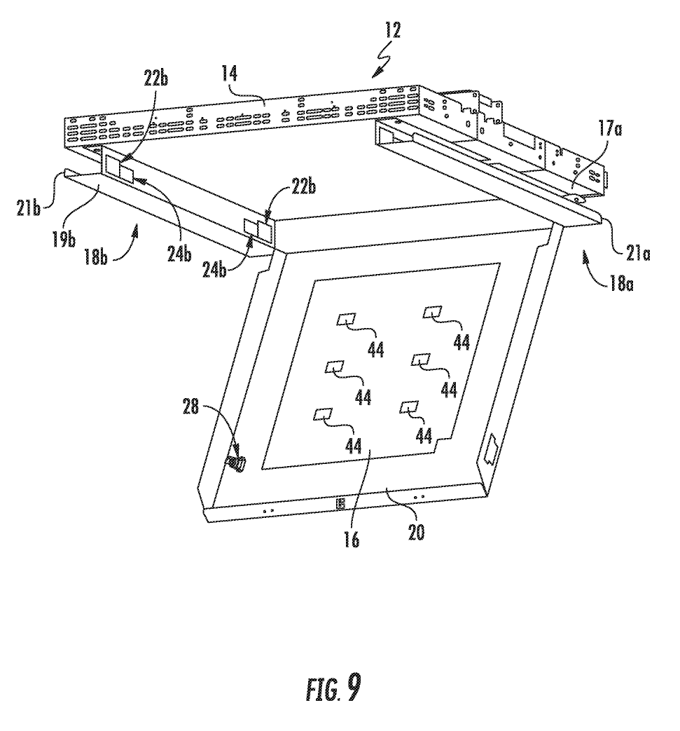

FIG. 9 depicts a configuration similar to FIG. 2, in which the ceiling panel has been pivoted out of its operating position into a maintenance position.

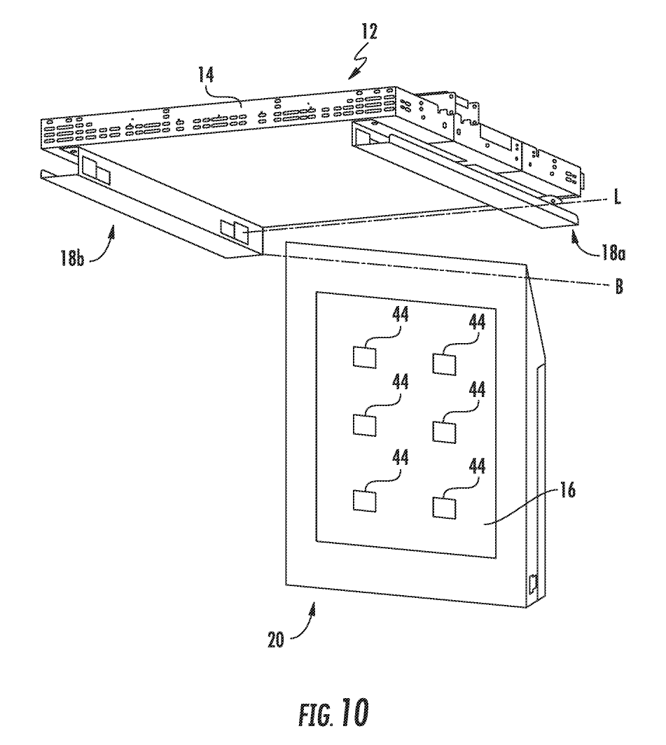

FIG. 10 depicts a configuration in which the ceiling panel has been removed from the ceiling.

FIG. 1 schematically depicts an elevator system 2 according to an exemplary embodiment of the invention.

The elevator system 2 includes an elevator car 6 comprising a floor 9 and a ceiling 12. The elevator car 6 is movably suspended within a hoistway 4 by means of a tension member 3. The tension member 3, for example a rope or belt, is connected to an elevator drive 5, which is configured for driving the tension member 3 in order to move the elevator car 6 along the height of the hoistway 4 between a plurality of landings 8 located on different floors.

Each landing 8 is provided with a landing door 10, and the elevator car 6 is provided with a corresponding elevator car door 11 for allowing passengers to transfer between a landing 8 and the interior of the elevator car 6 when the elevator car 6 is positioned at the respective landing 8.

The exemplary embodiment shown in FIG. 1 uses a 1:1 roping for suspending the elevator car 6. The skilled person, however, easily understands that the type of the roping is not essential for the invention and that different kinds of roping, e.g. a 2:1 roping or none roping at all, may be used as well. The elevator system 2 may use a counterweight (not shown) or not. The elevator drive 5 may be any form of drive used in the art, e.g. a traction drive, a hydraulic drive or a linear drive. The elevator system 2 may have a machine room or may be a machine room-less elevator system. The elevator system 2 may use a tension member 3, as it is shown in FIG. 1, or it may be an elevator system without a tension member 3.

The elevator drive 5 is controlled by an elevator control unit 13 for moving the elevator car 6 along the hoistway 4 between the different landings 8.

Input to the control unit 13 may be provided via an elevator car control panel 7b provided inside the elevator car 6 and/or landing control panels 7a, which are provided on each landing 8 close to the landing doors 10.

The elevator car control panel 7b and the landing control panels 7a may be connected to the elevator control unit 13 by means of electrical lines, which are not shown in FIG. 1, in particular by an electric bus, or by means of wireless data connections.

FIG. 2 shows an enlarged perspective view of a portion of the ceiling 12 of the elevator car 6 according to an exemplary embodiment of the invention.

In the embodiment shown in FIG. 2, the portion of the ceiling 12 comprises three structural panels 14 arranged adjacent to each other. The structural panels 14 are fixed to each other. This configuration, however, is only exemplary and the skilled person will understand that other configurations of the ceiling 12, in particular configurations comprising less or more structural panels 14, are possible as well.

Two elongated bars 18a, 18b extending parallel to and spaced apart from each other are attached to the bottom of the ceiling 12 facing the interior space of the elevator car 6.

Each of the bars 18a, 18b respectively comprises a first horizontal leg 15a, 15b attached to the structural panels 14, a first vertical leg 17a, 17b extending orthogonally from the first horizontal leg 15a, 15b and a second horizontal leg 19a, 19b extending basically orthogonally from the first vertical leg 17a, 17b, i.e. parallel to the first horizontal leg 15a, 15b and the ceiling 12.

Each of the bars 18a, 18b further comprises a second vertical leg 21a, 21b extending orthogonally from a portion of the second horizontal leg 19a, 19b opposite to the first vertical leg 17a, 17b and parallel to said first vertical leg 17a, 17b.

A ceiling panel 20 comprising a transparent central portion 16 is arranged in lo between the two bars 18a, 18b. The ceiling panel 20 may comprise and/or support lighting elements, e.g. lighting elements comprising LEOs, which are not visible in FIG. 2.

In the following description, the terms “rear”, “front”, “left” and “right” refer to the orientation of the exemplary embodiment shown in the figures. The skilled person will understand that the use of these terms does not restrict the invention to the depicted exemplary orientation.

The ceiling panel 20 is supported by the bars 18a, 18b such that it is pivotable around an axis (not shown in FIG. 2) which extends parallel to the ceiling 12 along a rear portion of the ceiling panel 20 between rear ends of the bars 18a, 18b.

The details of the attachment of the ceiling panel 20 to the bars 18a, 18b will be described further below with reference to the following figures.

A safety wire 40 extends between a safety hook 42 provided at a front portion of the ceiling panel 20 and one of the structural panels 14 in order to prevent the front end of the ceiling panel 20 from falling down. The safety wire 40 may be detached from the safety hook 42 in case the front end of the ceiling panel 20 is supposed to be lowered by pivoting the ceiling panel 20. This operation will be described in more detail further below.

FIG. 3 shows an enlarged partial view of a front area of a first bar 18a which is shown on the right side of FIG. 2.

Two openings 22a, 24a are formed in a front portion of the first vertical leg 17a of the first bar 18a: A first opening 22a having a basically quadratic shape with a small recess 23 formed in the lower edge of the first opening 22a, and a second opening 24a having a rectangular shape. Similar openings are formed in a rear portion (not shown) of the first bar 18a. As a result, the first bar 18a has mirror symmetry with respect to a virtual plane which extends orthogonally to the ceiling 12 through a center of the first bar 18a when the first bar 18a is viewed along its longitudinal direction.

FIG. 4a depicts a rear portion of the first bar 18a shown in FIG. 3 from an opposite side of view (from “outside”) in combination with the ceiling panel 20. The ceiling panel 20 is provided with a first protrusion 26a having the form of a pin 26a extending from a lateral side portion of the ceiling panel 20, which is a rear lateral side portion of the ceiling panel 20 in the orientation shown in FIG. 2. The first protrusion I pin 26a is received within the first opening 22a. The first protrusion I pin 26a in particular is received within the recess 23 formed within the lower edge of the first opening 22a for pivotably supporting the ceiling panel 20.

FIG. 4b depicts a second bar 18b, which is attached to the ceiling 12 of the elevator car 6 extending parallel to and spaced apart from the first bar 18a for supporting the ceiling panel 20. The second bar 18b is formed similar to the first bar 18a, in particular comprising first and second openings 22b, 24b. As in the first bar 18a, a recess 23, which is not visible in FIG. 4b, is formed within the lower edge of the first opening 22b.

A second protrusion I pin 26b is provided on an opposite lateral side of the ceiling panel 20. Said second protrusion I pin 26b is accommodated in a (not visible) recess 23 of the first opening 22b of the second bar 18b supporting the opposing side of the ceiling panel 20. The ceiling panel 20 in particular is supported such that it is pivotable around an axis extending between the two protrusions I pins 26a, 26b.

A ring 29a, 29b having a larger outer diameter then the recess 23 is provided at the end of each protrusion I pin 26a, 26b for preventing the protrusion I pin 26a, 26b from slipping out of the respective recess 23.

FIGS. 5 and 6 show an enlarged partial view of the left portion shown in FIG. 2.

FIGS. 5 and 6 in particular show a front portion of the second bar 18b and a left front portion of the ceiling panel 20 from different viewing directions.

A locking mechanism 28 is provided in a left front portion of the ceiling panel 20, which is opposite to the rear portion of the ceiling panel 20 supporting the protrusions I pins 26a, 26b as described before. The locking mechanism 28 is configured for engagement with the second (rectangular) opening 24b formed within the first vertical leg 17b of the second bar 18b. A corresponding locking mechanism 28 (not shown), which is configured for engagement with the second (rectangular) opening 24a formed within the first vertical leg 17a of the first bar 18a, may be provided in the opposite right front portion of the ceiling panel 20.

The locking mechanism 28 in particular comprises a movable protrusion element 27. The protrusion element 27 is moveable between an unlocked position, as it is shown in FIG. 5, and a locked position, as it is shown in FIG. 6. In its locked position, the protrusion element 27 extends through the second (rectangular) opening 24a, 24b of the respective bar 18a, 18b thereby locking the ceiling panel 20 to the bar 18a, 18b.

When the locking mechanism 28 is in its locked position, the ceiling panel 20 is fixed in an operating position in which it extends in a basically horizontal orientation parallel to the ceiling 12. In particular, any pivoting motion of the ceiling panel 20 around the axis extending between the two protrusions I pins 26a, 26b, which are accommodated within the first openings 22a, 22b formed in the rear portions of the bars 18a, 18b, is prevented when the protrusion element 27 is located in the locked position extending through the second opening 24a, 24b, as it is shown in FIG. 6.

FIG. 7 shows a perspective explosive view of an exemplary embodiment of the locking mechanism 28. The locking mechanism 28 comprises the protrusion element 27, which is pivotable around an axis A to be moved between the unlocked position shown in FIG. 5 and the locked position shown in FIG. 6.

The locking mechanism 28 further comprises an elastic element 32, such as a spiral spring, which is configured for urging the protrusion element 27 into its locked position.

The locking mechanism 28 also comprises a key receiving portion 34, which is configured for receiving a matching key 36 (not shown in FIG. 7) and for moving the protrusion element 27 from its locked position into an unlocked position by turning the key 36 around the axis A.

FIG. 8 shows a configuration similar to FIG. 2 in which the ceiling panel 20 is locked in the operating position extending basically parallel to the ceiling 12. A key 36 is introduced via one of two holes 38 provided within the ceiling panel 20 into the key receiving portion 34 of one of the locking mechanisms 28, which are not visible in FIG. 8. By turning the key 36 the protrusion element 27 of the locking mechanism 28 may be moved from its locked position into its unlocked position. After all locking mechanisms 28 have been moved into their respective unlocked positions, the ceiling panel 20 may be moved from its operating position into a maintenance position by pivoting the ceiling panel 20 around the axis extending between the two protrusions I pins 26a, 26b, which are accommodated within the first openings 22a, 22b (not visible in FIG. 8), as it is illustrated in FIG. 9. This provides access to lighting elements 44 arranged on the top side of the ceiling panel 20 facing the ceiling 12 when the ceiling panel 20 is arranged in its operating position. Additionally or alternatively lighting elements 44 may be provided at the bottom side of the structural panel 14 facing the ceiling panel 20.

FIG. 10 illustrates that the protrusions I pins 26a, 26b may be extracted from the first openings 22a, 22b by slightly tilting the ceiling panel 20 so that an axis B extending between the two protrusions I pins 26a, 26b of the ceiling panel 20 is inclined with respect to a straight line L connecting the two first openings 22a, 22b of the bars 18a, 18b. This allows to separate the ceiling panel 20 from the bars 18a, 18b and to remove the ceiling panel 20 from the ceiling 12 I elevator car 6.

A number of optional features are set out in the following. These features may be realized in particular embodiments, alone or in combination with any of the other features.

In one embodiment a first opening may be formed in a first portion of the respective bar next to a first end of the bar, and a second opening may be formed in a second portion of the respective bar next to an opposing second end of the bar. Such a configuration allows to support two opposing ends of the ceiling panel which results in a very stable structure.

In one embodiment, each of the bars may be formed symmetrically, in particular comprising a first and a second opening at a first end and a first and a second opening at an opposing second end, respectively. A symmetrically formed bar may be selectively used as a first bar and as second bar. In consequence, only a single type of bar needs to be produced and delivered. This allows reducing the costs for production and installation.

In one embodiment the first openings may be large enough for allowing to insert 5 the protrusions into and for removing the protrusions from the first openings by tilting the ceiling panel, in particular by tilting the ceiling panel in such a manner that the axis extending between the two protrusions of the ceiling panel is inclined with respect to a line connecting the two first openings of the bars. Such a configuration allows for an easy installation and removal of the ceiling panel.

In one embodiment the protrusions may be provided by pins, in particular by metallic pins. Pins, in particular metallic pins, allow for a secure support of the ceiling panel by the bars.

In one embodiment each of the first openings may comprise a recess which is configured for receiving a protrusion I pin of the ceiling panel. Such a recess allows to fix the protrusions I pins at a well-defined position within the first openings. This results in a secure installation of the ceiling panel.

In one embodiment, the ceiling panel may comprise at least one lighting element, which is configured for illuminating the interior space of the elevator car. The at least one lighting element in particular may include at least one LED or an LED panel.

In one embodiment, the ceiling panel may comprise at least one transparent portion allowing light to pass through the ceiling panel. In such a configuration lighting elements may be installed on the side of the ceiling panel facing away from the interior space of the elevator car. Such a configuration prevents passengers from touching, polluting and/or damaging the lighting elements.

In one embodiment, the locking mechanism may comprise an elastic element pro-viding a spring mechanism, which is configured for urging the locking mechanism into its locked position. Such a spring mechanism ensures that the locking mechanism moves into and stays within its locked position, thereby enhancing the safety of the elevator car. It further facilitates the installation of the ceiling panel, as pushing the ceiling panel into its operating position is sufficient for installing and securely fixing the ceiling panel.

In one embodiment, the locking mechanism may be configured for being unlocked by means of a key, in particular by a mechanical key, more particular by a triangular key. A locking mechanism which may be unlocked only by means of a key pre-vents an unauthorized removal of the ceiling panel. A mechanical key is reliable and may be provided at low costs.

In one embodiment, the ceiling panel may comprise two locking members, each of the two locking members being configured for engaging with one of the bars, respectively. The two locking members in particular may be provided at two opposing sides of the ceiling panel. Providing two locking members results in a symmetric configuration having a large stability.

In one embodiment, each of the bars may comprise at least a first leg and a second leg. The first leg in particular may be a vertical leg extending basically orthogonally from the ceiling of the elevator car. The second leg may be a horizontal leg, which extends basically orthogonally to the first leg and parallel to the ceiling. Such a geometry provides bars having a large mechanical stability.

In one embodiment, the first and second openings may be formed in the first leg. This allows for an easy installation and removal of the ceiling panel.

In one embodiment, the ceiling panel may be provided with a safety hook and are movable safety wire extending between the safety hook and a structural panel of the ceiling in order to avoid the front end of ceiling panel from falling down as soon as the locking mechanism(s) is/are unlocked. Such a safety wire provides additional safety to a mechanic removing the ceiling panel.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system
3 tension member
4 hoistway
5 drive
6 elevator car
7a landing control panel
7b elevator car control panel
8 landing
9 floor of the elevator car
10 landing door
11 elevator car door
12 ceiling of the elevator car
13 elevator control unit
14 structural panel
15a, 15b first horizontal leg
16 transparent portion
17a, 17b first (vertical) leg
18a first bar
18b second bar
19a, 19b second (horizontal) leg
20 ceiling panel
21a, 21b second vertical leg
22a, 22b first opening
23 recess
24a, 24b second opening
26a first protrusion I pin
26b second protrusion I pin
27 protrusion element
28 locking mechanism
29a, 29b ring
32 elastic element
34 key receiving portion
36 key
38 hole
40 safety wire
42 safety hook
44 lighting element

1. An elevator car (6) comprising:
a ceiling (12);
a first bar (18a) and a second bar (18b), both bars (18a, 18b) extending parallel to and spaced apart from each other along the ceiling (12), each of the bars (18a, 18b) comprising at least one first opening (22a, 22b) and at least one second opening (24a, 24b);
a ceiling panel (20) comprising:
a first protrusion (26a) and a second protrusion (26b), both protrusion (26a, 26b) extending from opposite sides of the ceiling panel (20), each protrusion (26a, 26b) being configured such as to be received within a first opening (22a, 22b) of one of the bars (18a, 18b) and for allowing for a pivoting motion of the ceiling panel (20) around an axis extending between the two protrusions (26a, 26b);
at least one locking mechanism (28), which is switchable between a locked state and an unlocked state;
wherein the at least one locking mechanism (28) in its locked state engages with one of the second openings (24a, 24b) to lock the ceiling panel (20) to at least one of the bars (18a, 18b) when the ceiling panel (20) is pivoted into an operating position in which the ceiling panel (20) extends parallel to the bars (18a, 18b); and
wherein the at least one locking mechanism (28) in its unlocked state allows the ceiling panel (20) to pivot from the operating position to a maintenance position in which the ceiling panel (20) is inclined with respect to the bars (18a, 18b).

2. The elevator car (6) according to claim 1, wherein a first opening (22a, 22b) is formed in a first portion of the respective bar (18a, 18b) next to a first end of said bar (18a, 18b), and wherein a second opening (24a, 24b) is formed in a second portion of the respective bar (18a, 18b) next to an opposing second end of said bar (18a, 18b).

3. The elevator car (6) according to claim 1, wherein each of the bars (18a, 18b) is formed symmetrically, in particular comprising a first opening (22a, 22b) and a second opening (24a, 24b) at its second end, respectively.

4. The elevator car (6) according to claim 1, wherein the first openings (22a, 22b) are large enough for allowing to insert the protrusions (26a, 26b) into and for removing the protrusions (26a, 26b) from the first openings (22a, 22b), in particular by tilting the ceiling panel (20) in such a manner that the axis extending between the two protrusions (26a, 26b) of the ceiling panel (20) is inclined with respect to a line connecting opposing first openings (22a, 22b) of the two bars (18a, 18b).

5. The elevator car (6) according to claim 1, wherein each of the first openings (22a, 22b) comprises a recess (23) which is configured for receiving a protrusion (26a, 26b).

6. The elevator car (6) according to claim 1, wherein the ceiling panel (20) comprises at least one lighting element (44), in particular a lighting element (44) comprising an LED or an LED panel.

7. The elevator car (6) according to claim 1, wherein the ceiling panel (20) comprises at least one transparent portion (16).

8. The elevator car (6) according to claim 1, wherein the protrusions (26a, 26b) are provided by pins, in particular metallic pins.

9. The elevator car (6) according to claim 1, wherein the locking mechanism (28) comprises an elastic element (32), which is configured for urging the locking mechanism (28) into its locked position.

10. The elevator car (6) according to claim 1, wherein the locking mechanism (28) is configured for being unlocked by means of a key (36), in particular by a mechanical key (36), more particularly by a triangular key (36).

11. The elevator car (6) according to claim 1, wherein the ceiling panel (20) comprises two locking mechanisms (28), wherein each of the two locking mechanisms (28) is configured for engaging with one of the bars (18a, 18b), respectively.

12. The elevator car (6) according to claim 1, wherein each of the bars (18a, 18b) comprises a first leg (17a, 17b) and a second leg (19a, 19b), and wherein the first openings (22a, 22b) and second openings (24a, 24b) are formed in the first leg (17a, 17b), wherein the first leg (17a, 17b) in particular extends basically orthogonally from the ceiling (12) of the elevator car (6) and/or wherein the first leg (17a, 17b) and the second leg (19a, 19b) in particular extend basically orthogonally to each other.

13. The elevator car (6) according to claim 1 further comprising at least one removable safety wire (40) extending between the ceiling panel (20) and the ceiling (12).

14. Method of mounting a ceiling panel (20) in an elevator car (6) according to claim 1 comprising:
introducing the first protrusion (26a) into a first opening (22a of the first bar (18a);
introducing the second protrusion (26b) into a first opening (22b) of the second bar (18b);
pivoting the ceiling panel (20) upwards around the axis extending between the protrusions (26a, 26b); and
locking the ceiling panel (20) to at least one of the bars (18a, 18b) by means of the at least one locking mechanism (28) when the ceiling panel (20) is oriented parallel to the bars (18a, 18b).

15. Method of removing a ceiling panel (20) from an elevator car (6) according to claim 1 comprising:
unlocking the at least one locking mechanism (28);
pivoting the ceiling panel (20) downwards around the axis extending between the protrusions (26a, 26b); and
extracting the protrusions (26a, 26b) from the respective first openings (22a, 22b).
